(19) United States
(12) Patent Application Publication
(10) Pub. No.: US 2025/0104570 A1
(43) Pub. Date: Mar. 27, 2025

(54) AUTOMATIC GENERATION OF INTERACTION TOOLS

(71) Applicant: Zoom Video Communications, Inc., San Jose, CA (US)

(72) Inventors: Bilung LEE, San Jose, CA (US); Vijay Venkataswamy Parthasarathy, San Jose, CA (US); Renjie Tao, Santa Clara, CA (US); Matthieu Tardivel, Montpellier (FR); Yun Zhang, Pittsburgh, PA (US)

(21) Appl. No.: 18/372,745

(22) Filed: Sep. 26, 2023

(51) Int. Cl. G09B 7/00; G06F 40/35; H04L 12/18; H04L 51/216

(52) U.S. Cl. CPC G09B 7/00; G06F 40/35; H04L 12/1831; H04L 51/216

(57) ABSTRACT

Example methods and systems for automatic generation of interaction tools. A communication platform receives a request to generate an interaction tool associated with a virtual communication session and accesses virtual communication data associated with the virtual communication session. The communication platform identifies a set of keypoint data from the virtual communication data based on the request using a machine learning model. The communication platform generates a list of questions based on the set of keypoint data and the request using a first generative artificial intelligence (AI) model. The communication platform provides the interaction tool based on the list of questions.

### FIELD

The present application generally relates to virtual communication and more specifically relates to automatic generation of interaction tools.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing and chat functionality to various client devices;

FIG. 2 shows an example system in which a chat and video conference provider provides videoconferencing and chat functionality to various client device;

FIG. 3 shows an example system that can establish a virtual communication session;

FIG. 4 shows an example system that is configured to automatically generate an interaction tool associated with a virtual communication session;

FIG. 5 shows an example GUI for generating a survey for a recorded video conference;

FIG. 6 shows an example GUI displaying a consent authorization request for accessing personal data;

FIG. 7 shows an example GUI of a video conference;

FIG. 8 shows an example method for automatically generating an interaction tool associated with a virtual communication session; and

FIG. 9 shows an example computing device suitable for use in example systems or methods for automatic generation of interaction tools, according to certain examples.

### DETAILED DESCRIPTION

Examples are described herein in the context of automatic generation of interaction tools. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Virtual communications, such as video conferences any other online interactions, become important ways for users to share information. Users may discuss various aspects related to a project, a deal, or any suitable subjects. A virtual communication host may want to utilize certain interaction tools, such as surveys, polls, or quizzes, to collect information or evaluate the effect of the virtual communication before, during, or after the virtual communication. However, it may take a long time for the host to review and sift through all the relevant information to design relevant interaction questions. It is also laborious to review user responses and distill insights from the user responses.

To facilitate interactive communication, it is desirable for a communication platform to automatically generate questions for an interaction tool (e.g., survey, poll, or quiz) and analyze responses collected from users via the interaction tool. For examples, the communication platform provides an interaction tool generation engine for automatically generating questions and an interaction analytics engine for analyzing responses and providing insights.

In an example, a communication platform establishes a video conference between a host and one or more users. The host and the one or more users join the video conference via client devices installed with a communication application. During or after the video conference, the host sends a signal via a graphical user interface (GUI) of the communication application (e.g., press or click a button) to the communication platform for generating an interaction tool, such as a survey. The host can provide a prompt describing certain features of the interaction tool.

The communication platform includes an interaction tool generation engine configured to generate interaction questions as part of the interaction tool. The interaction tool generation engine can obtain consent to access the video conference data, such as recording, transcript, shared files, or other related data, and metadata of the video conference data, and prompt from the host.

The interaction tool generation engine can identify keypoint data (e.g., information relevant to a topic specified by the host in a prompt) from the video conference data and metadata based on the prompt. The interaction tool generation engine can implement a natural language processing (NLP)-based machine learning model to analyze the video conference data and identify keypoint data.

The interaction tool generation engine generates questions based on the keypoint data, using a first generative artificial intelligence (AI) model. The interaction tool generation engine can also generate answers corresponding to the generated questions, using a second generative AI model. The first generative AI model for question generation and the second generative AI model for answer generation can be two separate models or the same model. Answer generation can be optional, because certain questions are designed to collect information not to test accuracy, such as survey questions or poll questions. For questions that are designed to test accuracy, such as quiz questions, answers paired with questions can be generated for the host.

The host can select some or all of the generated questions, or edit some questions, for generating an interaction tool. The interaction tool generation engine can then generate an interaction tool including the host-approved questions and transmits to participants. For example, the interaction tool is a survey, it can be sent to participants at the end or after the video conference. The survey questions can be displayed in the GUI of the client application at the end of the video conference. Alternatively, the survey questions can be sent to participants via email, chat, or any other suitable means. The communication platform also includes an interaction analytics engine configured to analyze the participant responses via the interaction tool. If the questions do not have right answers, such as survey or poll questions, the interaction analytics engine can aggregate the participant responses to provide statistics, patterns, or any other insight. If the questions have right answers, such as quiz questions, the interaction analytics engine can determine scores for the participants, and aggregate the participant responses and scores to provide statistics, patterns, or any other insight. The insight data provided by the analytics engine can be provided to the host.

In some examples, the interaction analytics engine can update or generate the prompt based on the insight data and provide the updated prompt or a new prompt to the host for generating an updated or new interaction tool with updated or new questions. For example, the quiz results show a low passage rate. The interaction analytics engine can generate an updated prompt, for example changing from “five answer choices” to “four answer choices,” changing a difficult testing topic to an easier testing topic, etc.

Thus, this example provides an automatically generated interaction tool. During or after a virtual communication, such as a video conference, a host can select to employ an interaction tool, such as a survey. The host can provide a prompt describing the features of the interaction tool. Questions and answers can be generated based on communication data, communication metadata, and the prompt. The host can simply select what questions to include in the interaction tool without spending time reviewing the content of the virtual communication and design the questions. Responses from users can be analyzed to provide insight to the host. The host may adjust the prompt to update the interaction tool or take other actions based on the insight.

Applicant's goal is to invest in AI-driven innovation that enhances user experience and productivity while prioritizing trust, safety, and privacy. Applicant does not use any customer audio, video, chat, screen-sharing, attachments, or other communications-like customer content (such as poll results, whiteboards, or reactions) to train Applicant's or third-party artificial intelligence models. Additionally, AI-enabled features are turned off by default—account owners and administrators control whether to enable these AI features for their accounts. Applicant provides admins and users control and visibility when AI features are being used or activated. By putting its customers' privacy needs first, Applicant is taking a leadership position, enabling its customers to use AI-powered tools and its capabilities with confidence.

This illustrative example is given to introduce the reader to the general subject matter discussed herein and the disclosure is not limited to this example. The following sections describe various additional non-limiting examples and examples of automatic generation of interaction tools.

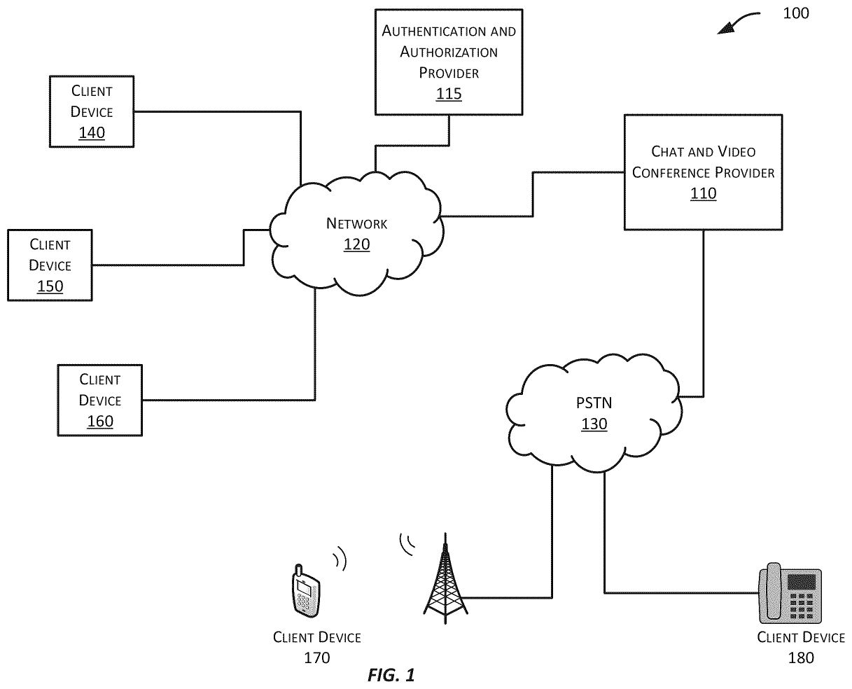

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

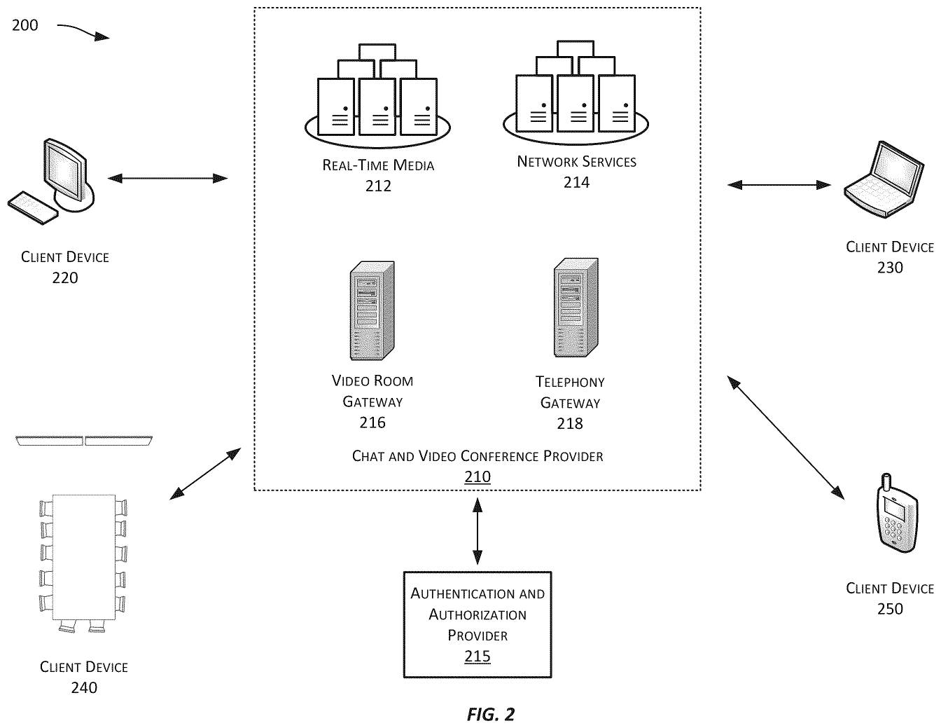

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

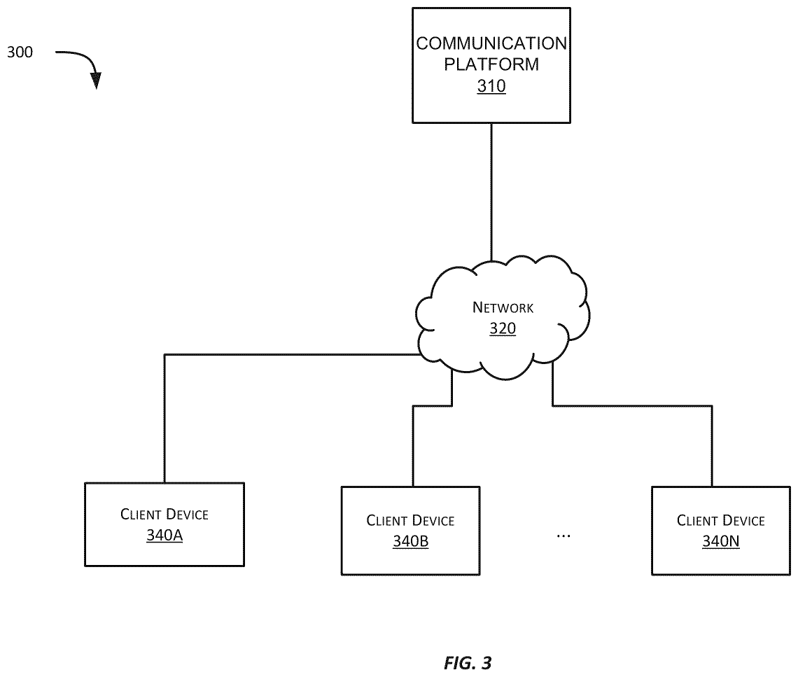

Referring now to FIG. 3, FIG. 3 shows an example system 300 that can establish a virtual communication session. In this example system 300, a communication platform 310 and a number of client device 340A-340N (which may be referred to herein individually as a client device 340 or collectively as the client devices 340) are connected via a network 320. The communication platform 310 can be the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the communication platform 310 using the internet or other suitable computer network. The client devices 340 have communication software installed to enable them to connect to the communication platform 310 for chats, video conferences, emails, and any other suitable communications. For example, during a chat session, a user associated a client device (e.g., client device 340A) can interact with other users associated with other client devices (e.g., client device 340B-340N) via the communication platform 310 by sending and receiving chat messages, and reacting to received chat messages.

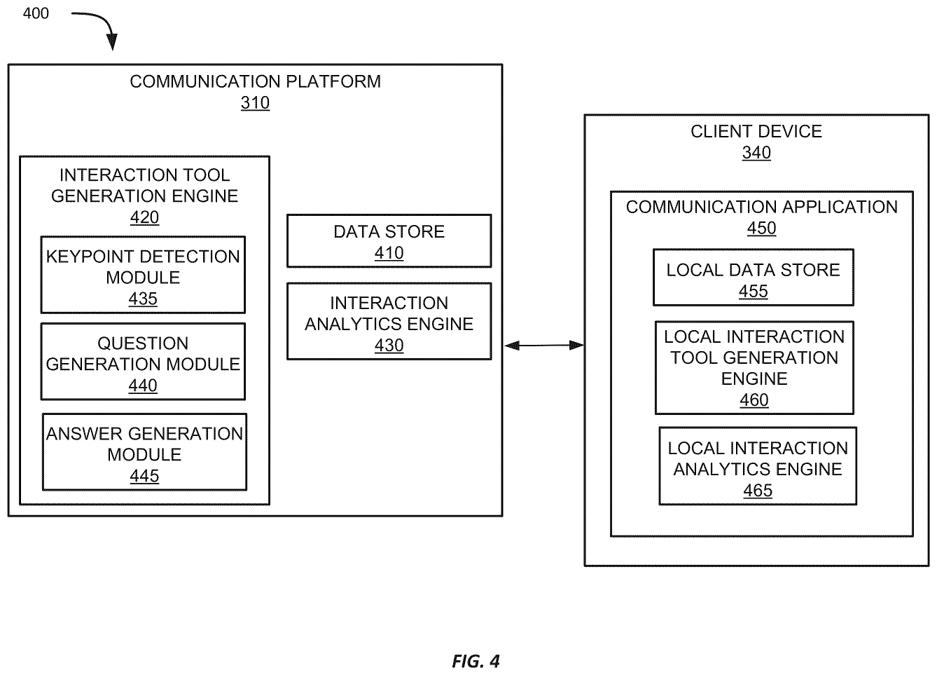

Now referring to FIG. 4, FIG. 4 shows an example system 400 that is configured to automatically generate an interaction tool associated with a virtual communication session. The communication platform 310 is in network communication with a client device 340. The client device 340 is installed with a communication application 450 provided by the communication platform 310.

The communication platform 310 includes a data store 410, an interaction tool generation engine 420, and an interaction analytics engine 430. The data store 410 stores virtual communication data and metadata associated with different virtual communication sessions established on the communication platform 310. The virtual communication sessions can be video conference sessions, chat sessions, or email threads. The virtual communication data associated with a video conference session can include one or more of a recording of the video conference session, a transcript of the recording, and shared documents during the video conference session. The metadata associated with the video conference session can include one or more of a title of the video conference session, a start and end time of the video conference session, a description of the video conference session, an agenda of the video conference session, and participant data associated with the video conference session. The virtual communication data associated with a chat session can include chat messages. The chat messages can be text-based messages, hyperlinks, or documents. The metadata associated with the chat session can include one or more of a topic of the chat session, a start and end time of the chat session, the participant data associated with the chat session. The virtual communication data associated with an email thread can include the email content in the email thread. The metadata associated with the email thread can include one or more of a subject of the email thread, a send time of an email in the email thread, and sender and recipient data associated with an email in the email thread.

The interaction tool generation engine 420 is configured to generate an interaction tool associated with a virtual communication session based on a user request. The interaction tool can be a survey including multiple questions designed to collect user data or opinion at the end of or after the virtual communication session. The interaction tool can also be a poll including one or more questions designed to collect user feedback during the virtual interaction session. Alternatively, the interaction tool can be a quiz including questions designed to test users. For example, a host of a virtual communication session can transmit a request to generate an interaction tool to the communication platform 310. The host can click or press a button (e.g., an interaction tool generation button) via a GUI of a communication application 450, which will be described in detail later. A pop-up window may be displayed for the host user to provide a prompt including a description of the interaction tool to be generated. The description can include a type of the interaction tool, a subject area for the list of questions to be generated, and a style of the list of questions or corresponding answers. The style of the list of questions or corresponding answers can include free form answers or multiple answer options. The free form answers may have a maximum character limit. For multiple answer options, the host user may specify how many answer options for one question (e.g., 2, 3, 4, or 5).

The interaction tool generation engine 420 includes a keypoint detection module 435 configured to identify keypoint data from virtual communication data associated with the virtual communication session based on user request. The keypoint detection module 435 can access the virtual communication data with user consent, and identify relevant information based on the prompt describing the interaction tool to be generated. The keypoint detection module 435 can implement a natural language processing (NLP)-based machine learning module to analyze the virtual communication data to identify information relevant to the subject area or other information specified in the prompt for interaction tool generation. For example, the keypoint data includes data that is related to a subject area specified in the prompt. The keypoint data can include data segments extracted from the virtual communication data. In some examples, the keypoint detection module 435 can also access metadata associated with the virtual communication data, for example, a title of the virtual communication session, a start and end time of the virtual communication session, a description of the virtual communication session, an agenda of the virtual communication session, or participant data associated with the virtual communication session. The NLP-based machine learning model can also analyze the metadata to identify the keypoint data.

The interaction tool generation engine 420 also includes a question generation module 440 configured to generate questions based on the keypoint data and the prompt. The question generation module 440 can implement a first generative AI model for generating questions for the interaction tool. The first generative AI model can be pre-trained with labeled questions as training output and corresponding content data as training input. The content data used as training input can include publicly available content data or mockup virtual communication data. Labeled questions can be created manually and used as training output. The pre-trained first generative AI model can also determine the persona and the tone of the questions based on host data, recipient data, purpose of the interaction tool, or any specifications in the user request.

The interaction tool generation engine 420 can also include an answer generation module 445 configured to generate answers corresponding to the generated questions, using a second generative AI model. The second generative AI model can be pre-trained with labeled questions and labeled answers as training output and corresponding content data as training input. The same content data as used for training the first generative AI model for question generation can be used as training input for training the second generative AI model for answer generation. The same labeled questions as used for training the first generative AI model for question generation can be used as part of the training output for training the second generative AI model. Besides, answers to the labeled questions can be created and labeled for training the second generative AI model as part of training output. The second generative AI model can generate answers to the generated questions based on the keypoint data from the virtual communication data and the prompt. In some examples, the first generative AI model for question generation and the second generative AI model for answer generation are separate models. In some examples, the first generative AI model for question generation and the second generative AI model for answer generation are the same model.

However, answer generation can be optional, because certain questions are designed to collect information not to test accuracy, such as survey questions or poll questions. For questions that are designed to test accuracy, such as quiz questions, answers paired with questions can be generated for the host. In some examples, one generative AI model is implemented for generating question-answer pairs based on keypoint data of the virtual communication data and the prompt. The generated questions and answers can be provided to the host for selection or edit.

The interaction tool generation engine 420 can generate an interaction tool including host-approved questions and transmit the interaction tool to participants during, at the end of, or after the virtual communication session. For example, if the interaction tool is a survey, it can be sent to participants at the end or after the video conference. The survey questions can be displayed in the GUI of the communication application 450 at the end of the video conference. Alternatively, the survey questions can be sent to participants via email, chat, or any other suitable means. The email or chat can include a hyperlink to a webpage including survey questions or a document attachment including the survey questions. The webpage or the document attachment may include a “submit” button for automatically submitting answers to the survey questions to the communication platform 310. If the interaction tool is a poll during the video conference, one or more poll questions can be displayed at a time to participants via the GUI of the communication application 450. If the interaction tool is a quiz, the quiz questions can be displayed in the GUI of the communication application 450 at the end of the video conference or at an appropriate time during the video conference specified by the host. Alternatively, the quiz questions can be sent to participants via email, chat, or any other suitable means at the end of or after the video conference. The quiz questions and corresponding answers can be sent to the host via email, chat, or other suitable means.

The interaction analytics engine 430 is configured to analyze participant responses collected from the interaction tool. If the questions do not have right answers, such as survey or poll questions, the interaction analytics engine 430 can aggregate the participant responses to provide statistics, patterns, or any other analytics data. If the questions have right answers, such as quiz questions, the interaction analytics engine 430 can determine scores for the participants, and aggregate the participant responses and scores to provide statistics, patterns, or any other analytics data. The analytics data provided by the interaction analytics engine 430 can be provided to the host.

In some examples, the interaction analytics engine 430 can update the host provided prompt or generate a new prompt based on the analytics data and provide the updated prompt or the new prompt to the host. The host may elect to regenerate or update the interaction tool using the updated prompt or the new prompt. For example, the results of a quiz show a low passage rate. The interaction analytics engine 430 can generate an updated prompt, for example changing from “five answer choices” to “four answer choices,” changing a difficult subject area to an easier testing subject area for testing, etc.

The communication application 450 installed on the client device 340 can include a local data store 455, a local interaction tool generation engine 460, and a local interaction analytics engine 465. The local data store 455 can store virtual communication data associated with virtual communication sessions hosted or joined by the local user associated with the client device 340. The local interaction tool generation engine 460 can be configured or trained by the communication platform 310 to generate questions and answers (optional) for an interaction tool based on virtual communication data stored in the local data store 455 or other accessible data, similar to the interaction tool generation engine 420 as described above. The local interaction analytics engine 465 can analyze responses collected from different users by the interaction tool and provide analytics or insight to the local user, similar to the interaction analytics engine 430 as described above.

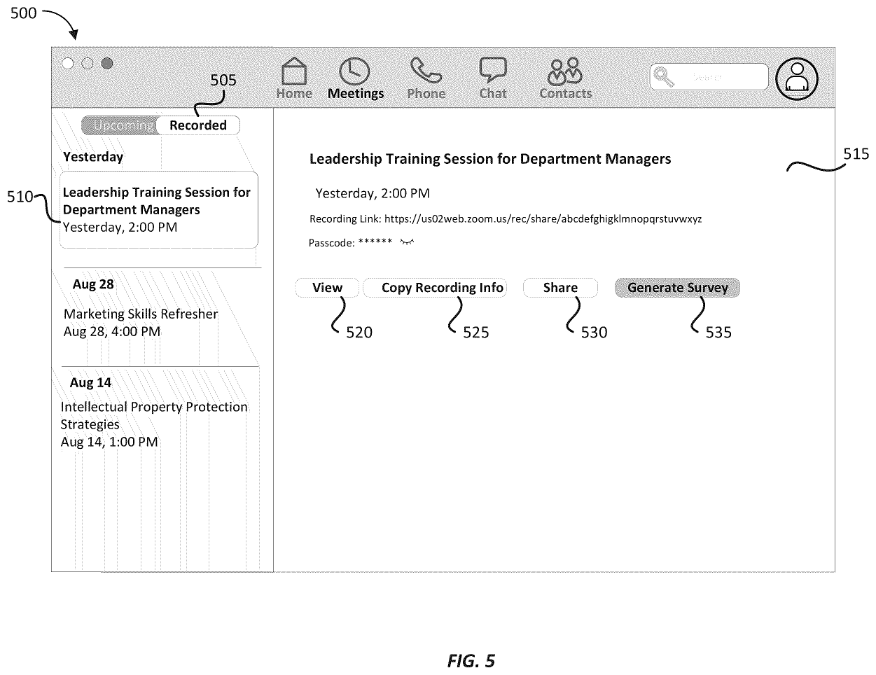

Now referring to FIG. 5, FIG. 5 shows an example GUI 500 for generating a survey for a recorded video conference. The GUI 500 displays a list of recorded meetings 505. A user selects the recorded meeting 510. Information about the recorded meeting 510 is displayed in the display window 515. The display window 515 also includes multiple buttons associated with various functionalities. For example, the “view” button 520 enables the user to view the recording. The “copy recording info” button 525 enables the user to copy the recording information, such as the recording link and the passcode to clipboard. The “share” button 530 enables the user to share the recording with another user. When the user clicks or touches the “share” button 530, a popup window or a webpage (not shown) is opened including the recording information and a field for the user to type an email address or a name, to whom the user would send the recording. In addition, the display window 515 also includes a “generate survey” button. If a user clicks or touches the “generate survey” button 535, a popup window or a webpage (not shown) can be opened for the user to type in a prompt describing the subject area or topic that the user wants to collect opinion from participants of the recorded meeting 510, the number of questions the user wants to include in the survey, or other requirements from the user.

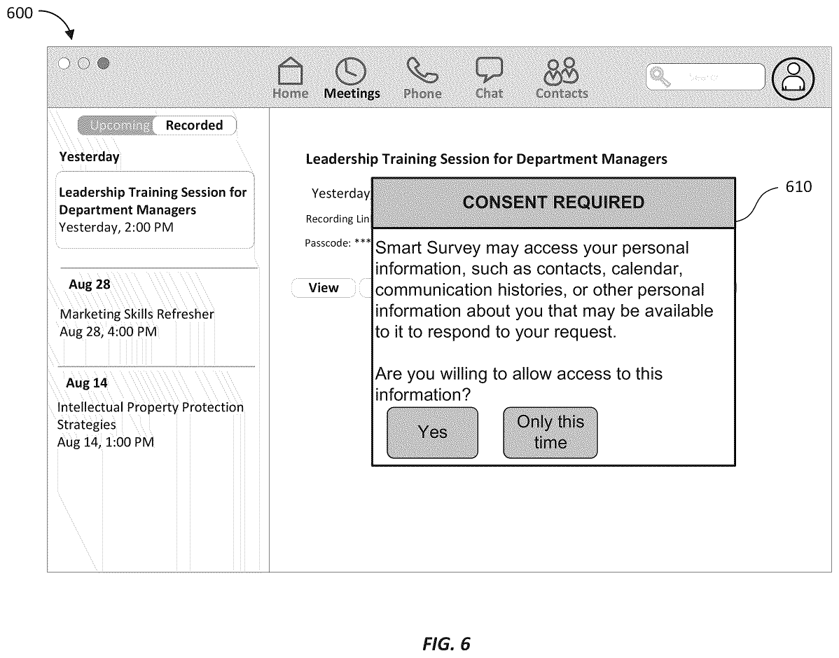

Now referring to FIG. 6, FIG. 6 shows an example GUI 600 displaying a consent authorization request for accessing personal data. If a user clicks or touches the “generate survey” button 535 in FIG. 5 intending to generate a survey related to the recorded meeting 510, a consent authorization is then displayed in a GUI element 610 for the user to interact with. The consent authorization informs the user that the survey generation feature may involve the communication platform 310 accessing multiple different types of information, which may be personal to the user. The user can decide whether to grant permission to the communication platform 310 generally or only for this request. Alternatively, the user can decline to provide permission, which may prevent the communication platform 310 from accessing the user's personal information to generate a survey.

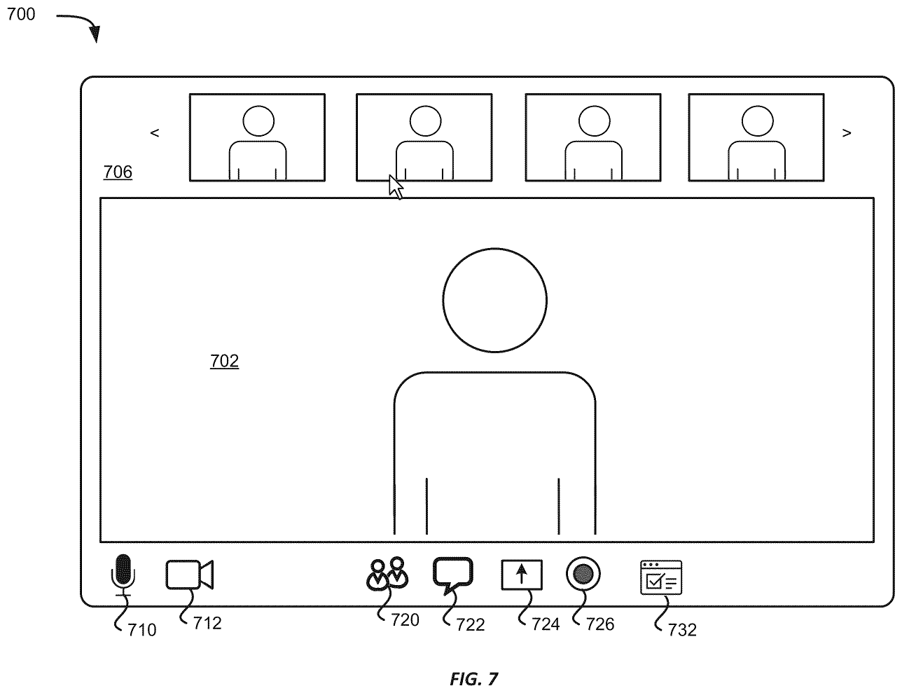

Now referring to FIG. 7, FIG. 7 shows an example GUI 700 of a video conference. The example GUI 700 shows a speaker window 702 displaying a camera view of a speaker and a participant panel 706 displaying the camera views of the participants of the video conference. The example GUI 700 also includes multiple interactive buttons for facilitating interaction during the video conference. For example, the microphone button 710 can be enabled or disabled to unmute or mute the user during the video conference. The camera button 712 can be enabled or disabled to display or undisplay the camera view of the user. The participant button 720 enables the user to view a list of participants in the video conference. The chat button 722 enables the user to send or receive chat messages to and from other participants. The share button 724 enables the user to share screen during the video conference. The record button 726 enables the user to record the video conference with authorization or consent. In addition, the survey button 732 enables the user to request a survey to be generated related to the video conference. The user can click the survey button 732 during or at the end of the video conference. A popup window (not shown) can be displayed for the user to type in a prompt describing certain requirements for the survey. The communication platform 310 can generate a survey based on the prompt and the video conference data or documents shared during the video conference, generally as described in FIG. 4.

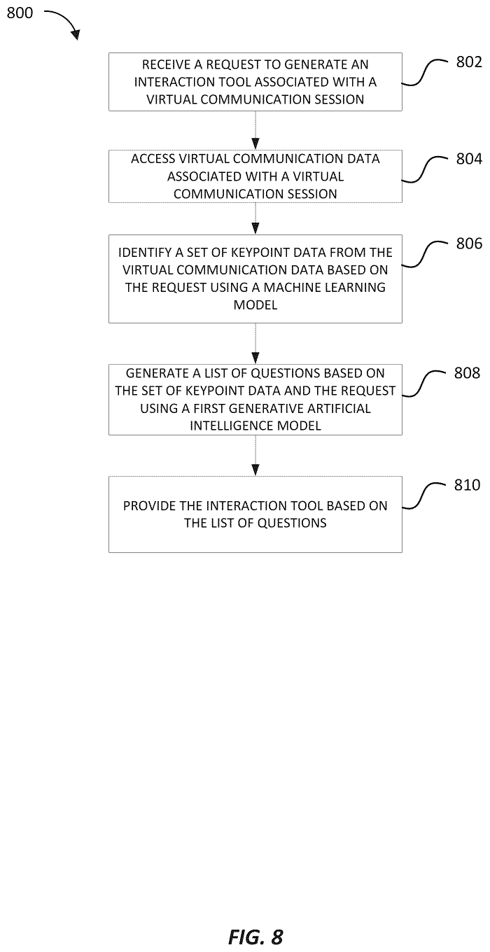

Now referring to FIG. 8, FIG. 8 shows an example method 800 for automatically generating an interaction tool associated with a virtual communication session. The example method 800 will be discussed with respect to the system 400 shown in FIG. 4; however, any suitable system for automatic generation of interaction tools may be used.

At block 802, a communication platform 310 receives a user request to generate an interaction tool associated with a virtual communication session. A user, such as a host of the virtual communication session may want to use an interaction tool, such as a survey, poll, or quiz, during or after the virtual communication session, to collect data or opinion, or to test the effectiveness of the virtual communication session. The user can activate a button (e.g., button 535 in FIG. 5 or button 732 in FIG. 7) in a GUI of a communication application 450 associated with the communication platform 310 to type in a request describing a type of interaction tool the user wants, a subject area for a list of questions to be included in the interaction tool, or a style of answers to be list of questions.

At block 804, the communication platform 310 accesses virtual communication data associated with the virtual communication session. In response to the user request to generate an interaction tool received from a user, the interaction tool generation engine 420 on the communication platform 310 can access virtual communication data associated with the virtual communication session. If the virtual communication session is a video conference, the virtual communication data can include a recording or a transcript of the video conference, or any shared documents associated with the video conference. If the virtual communication session is an online chat session, the virtual communication data comprises multiple chat messages or any shared documents during the chat session. If the virtual communication session is an email thread, the virtual communication data includes multiple emails or document attachment or webpage links in the multiple emails. In addition, the interaction tool generation engine 420 can also access the metadata of a virtual communication session. Some examples of the metadata of the virtual communication session include a title of the virtual communication session, a start and end time of the virtual communication session, a description of the virtual communication session, an agenda of the virtual communication session, and participant data associated with the virtual communication session.

At block 806, the communication platform 310 identifies a set of keypoint data from the virtual communication data based on the user request using a machine learning model. The interaction tool generation engine 420 can identify a set of keypoint data from the virtual communication data, generally as described in FIG. 4. For example, the interaction tool generation engine 420 implements an NLP-based machine learning model to analyze the virtual communication data based on the user request received at block 802. If the user request specifies a subject area for the interaction tool, the NLP-based machine learning model can identify keypoint data related to the subject area from the virtual communication data. The keypoint data can include data segments from the virtual communication data, such as various sections from a transcript. In addition, the interaction tool generation engine 420 can identify keypoint data based on metadata associated with the virtual communication session. For example, the title and the description of the virtual communication session can be used to identify keypoint data in the virtual communication data.

At block 810, the communication platform 310 generates a list of questions based on the set of keypoint data and the user request using a generative AI mode. The question generation module 440 of the interaction tool generation engine 420 on the communication platform 310 can generate a list of questions based on the set of keypoint data and the user request, generally as described in FIG. 4. For example, the question generation module 440 implements a pre-trained generative AI model to generate questions from the keypoint data identified at block 808 and the user request. The user request can specify the types of questions to generate, such as free-form questions or multiple-choice questions. The pre-trained generative AI model can also determine the persona or tone of the questions based on host data and recipient data. For example, the persona of the survey questions can be professional for a business-related video conference. Also for example, the tone of the questions can be warm when the recipients are customers or potential customers. In addition, an answer generation module 445 can generate answers to the questions, if applicable. In some examples, the question generation module 440 and the answer generation module 445 can be one module configured to generate questions and answers based on the virtual communication data.

At block 812, the communication platform 310 provides the interaction tool based on the list of questions. The communication platform 310 can provide the list of questions to the host user for selection or editing. The interaction tool generation engine 420 can generate an interaction tool based on the host-approved questions. For example, multiple answer choices are enabled for selection, blank fields are enabled for entering responses. The generated interaction tool can be transmitted to multiple participants specified by the host user. The generated interaction tool can be presented in a popup window via the GUI of the communication application 450 associated the virtual communication session. The generated interaction tool can also be sent as a hyperlink or a document via email or chat. Participants can provide responses to the questions included in the interaction tool. The responses can be recorded and transmitted to the communication platform 310. The interaction analytics engine 430 on the communication platform 310 can analyze the responses, generally as described in FIG. 4. The analytics data can be transmitted to the host user.

The example process 800 illustrates a method for automatically generating an interaction tool. However, not every step in the example process 800 may be needed, or some steps may be in a different order. The example process 800 is performed by a communication platform 310. Alternatively, the example process 800 can be performed by a communication application 450 installed on a client device 340.

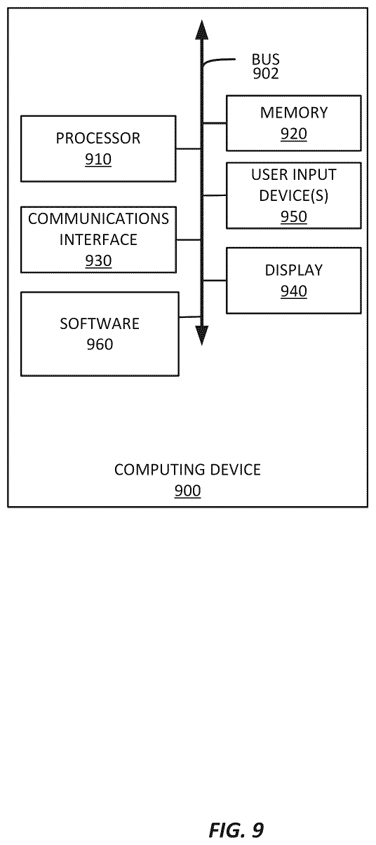

Now referring to FIG. 9, FIG. 9 shows an example computing device 900 suitable for use in example systems or methods for automatic generation of interaction tools. The example computing device 900 includes a processor 910 which is in communication with the memory 920 and other components of the computing device 900 using one or more communications buses 902. The processor 910 is configured to execute processor-executable instructions stored in the memory 920 to perform one or more methods for automatically generating interaction tools, such as part or all of the example method 800, described above with respect to FIG. 8. The computing device, in this example, also includes one or more user input devices 950, such as a keyboard, mouse, touchscreen, video input device (e.g., one or more cameras), microphone, etc., to accept user input. The computing device 900 also includes a display 940 to provide visual output to a user. The computing device 900 may also include a software 960. The software 960 may include a communication application (client application), a communication platform, and any other software to enable communication from a first user to a second user.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving a request to generate an interaction tool associated with a virtual communication session;
accessing virtual communication data associated with the virtual communication session;
identifying a set of keypoint data from the virtual communication data based on the request using a machine learning model;
generating a list of questions based on the set of keypoint data and the request using a first generative artificial intelligence (AI) model; and
providing the interaction tool based on the list of questions.

2. The method of claim 1, wherein the virtual communication session is an online chat session, and wherein the virtual communication data comprises multiple chat messages in the online chat session.

3. The method of claim 1, wherein the virtual communication session is a virtual conference, and wherein the virtual communication data comprises a transcript for the virtual conference, or shared documents during the virtual conference.

4. The method of claim 1, wherein the virtual communication session is an email thread, and wherein the virtual communication data comprises a sequence of emails.

5. The method of claim 1, further comprising:
accessing metadata related to the virtual communication session, wherein the metadata comprises one or more of a title of the virtual communication session, a start and end time of the virtual communication session, a description of the virtual communication session, an agenda of the virtual communication session, or participant data associated with the virtual communication session; and
identifying the set of keypoint data from the virtual communication data based on the metadata and the request using the machine learning model.

6. The method of claim 1, wherein the request comprises a type of the interaction tool, a subject area for the list of questions to be generated, and a style of answers to the list of questions to be generated.

7. The method of claim 6, wherein the type of the interaction tool comprises survey, poll, or quiz.

8. The method of claim 1, further comprising generating answers corresponding to the list of questions based on the virtual communication data and the request using a second generative AI model.

9. The method of claim 1, further comprising:
receiving a selection of multiple questions out of the list of questions;
generating the interaction tool comprising the multiple questions;
transmitting the interaction tool to a plurality of client devices; and
receiving one or more responses to the multiple questions via the interaction tool from the plurality of client device.

10. The method of claim 9, further comprising:
analyzing the one or more responses to generate analytics data; and
providing the analytics data to a host client device associated with the virtual communication session.

11. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
receive a request to generate an interaction tool associated with a virtual communication session;
access virtual communication data associated with the virtual communication session;
identify a set of keypoint data from the virtual communication data based on the request using a machine learning model;
generate a list of questions based on the set of keypoint data and the request using a first generative artificial intelligence (AI) model; and
provide the interaction tool based on the list of questions.

12. The system of claim 11, wherein the one or more processors are configured to
execute further processor-executable instructions stored in the non-transitory computer-readable medium to:
access metadata related to the virtual communication session, wherein the metadata comprises one or more of a title of the virtual communication session, a start and end time of the virtual communication session, a description of the virtual communication session, an agenda of the virtual communication session, or participant data associated with the virtual communication session; and
identify the set of keypoint data from the virtual communication data based on the metadata and the request using the machine learning model.

13. The system of claim 11, wherein the request comprises a type of the interaction tool, a subject area for the list of questions to be generated, and a style of answers to the list of questions to be generated; and wherein the type of the interaction tool comprises survey, poll, or quiz.

14. The system of claim 11, wherein the one or more processors are configured to execute further processor-executable instructions stored in the non-transitory computer-readable medium to:
generate answers corresponding to the list of questions based on the virtual communication data and the request using a second generative AI model.

15. The system of claim 11, wherein the one or more processors are configured to execute further processor-executable instructions stored in the non-transitory computer-readable medium to:
receive a selection of multiple questions out of the list of questions;
generate the interaction tool comprising the multiple questions;
transmit the interaction tool to a plurality of client devices; and
receive one or more responses to the multiple questions via the interaction tool from the plurality of client device.

16. The system of claim 15, wherein the one or more processors are configured to execute further processor-executable instructions stored in the non-transitory computer-readable medium to:
analyze the one or more responses to generate analytics data; and
provide the analytics data to a host client device associated with the virtual communication session.

17. A non-transitory computer-readable medium comprising processor-executable instructions configured to cause one or more processors to:
receive a request to generate an interaction tool associated with a virtual communication session;
access virtual communication data associated with the virtual communication session;
identify a set of keypoint data from the virtual communication data based on the request using a machine learning model;
generate a list of questions based on the set of keypoint data and the request using a first generative artificial intelligence (AI) model; and
provide the interaction tool based on the list of questions.

18. The non-transitory computer-readable medium of claim 17, further comprising processor-executable instructions configured to cause one or more processors to:
generate answers corresponding to the list of questions based on the virtual communication data and the request using a second generative AI model.

19. The non-transitory computer-readable medium of claim 17, further comprising processor-executable instructions configured to cause one or more processors to:
receive a selection of multiple questions out of the list of questions;
generate the interaction tool comprising the multiple questions;
transmit the interaction tool to a plurality of client devices; and
receive one or more responses to the multiple questions via the interaction tool from the plurality of client device.

20. The non-transitory computer-readable medium of claim 19, further comprising processor-executable instructions configured to cause one or more processors to:
analyze the one or more responses to generate analytics data; and
provide the analytics data to a host client device associated with the virtual communication session.
